(19) United States
(12) Patent Application Publication
(10) Pub. No.: US 2023/0221425 A1
(43) Pub. Date: Jul. 13, 2023

(54) SIMULTANEOUS IDENTIFICATION AND LOCALIZATION OF OBJECTS BY MEANS OF BISTATIC MEASUREMENT

(71) Applicant: Siemens Mobility GmbH, München (DE)

(72) Inventors: Stefan Edstaller, Erlbach (DE); Dominik Müller, Eichenau (DE)

(21) Appl. No.: 18/009,075

(22) PCT Filed: Apr. 1, 2021
(86) PCT No.: PCT/EP2021/058669

§ 371 Date: Dec. 8, 2022

(30) Foreign Application Priority Data
Jun. 8, 2020 (DE) 10 2020 207 135.7

(51) Int. Cl. G01S 13/34; G01S 13/58; G01S 13/00

(52) U.S. Cl. CPC G01S 13/341; G01S 13/58; G01S 13/003; G01S 2013/468

(57) ABSTRACT

A system identifies and localizes an object. The system contains a bistatic FMCW radar sensor system having two FMCW radar sensors and is configured to operate coherently or quasi-coherently and to emit a series of repeating ramp signals. An active RFID transponder is disposed on an object to be identified and to be localized and is configured to produce a modulated bistatic backscatter signal. A ramp signal sent out by the radar sensors at a ramp repetition frequency is modulated with an amplitude modulation signal, the modulation frequency is less than half the ramp repetition frequency. An evaluation unit establishes an association between a beat frequency and the modulation frequency of the active RFID transponder, which modulation frequency is already known, on the basis of the modulated bistatic backscatter signal by two Fourier transforms of the modulated backscatter signal according to the frequency and to the amplitude.

The invention relates to a system for identification and localization of an object. The invention additionally relates to a method for identification and localization of an object.

Modern industrial production is increasingly using autonomous and partly autonomous systems which can carry out production processes without any direct action or monitoring by operating personnel. In this regard the production processes comprise work operations at different stations of a production line and also transport between the individual stations. To achieve smooth interoperation and to ensure safety it is necessary to capture objects automatically, identify them, and determine their kinematic parameters, such as position, velocity and direction of movement.

In the case of a large number of objects in a production line, the individual objects and their paths to the next process step or to the next station need to be monitored and controlled. In a production workshop, this is dealt with by monitoring sensors, by means of which the workshop is monitored and data is made available for the process control system. In this regard the work pieces need to be identified and localized.

Autonomous motion also demands precise knowledge of the position and velocity of objects situated in the vicinity of a travel route of an autonomously controlled vehicle.

In this regard an autonomously moving vehicle needs to capture the surroundings by using sensor technology. If objects can not only be captured but also identified, then an appraisal of the danger to the vehicle emanating from an object can also be made independently of the accuracy of the position or velocity measurement. For example stationary infrastructure arranged on the travel route can be distinguished from potentially dangerous movable objects by this means.

For example objects can be identified with the help of so-called RFID transponders (RFID=radio frequency identification). The objects to be identified are fitted with such RFID transponders. A so-called RFID reader, that is to say a type of reading device, is used to capture and evaluate the signals from the transponders. RFID transponders can be designed both as passive and also as active transponders. Passive transponders are addressed by the reader by means of a signal, and modulate the signal passively. That is to say they do not have their own energy source with which they could actively send out a signal. Passive RFID transponders are only suitable for data transmission over short distances, for example one to three meters. On the other hand active RFID transponders have an electrical energy source themselves and can consequently send out a signal autonomously, which in turn can be received by an RFID reader. In the case of a passive RFID transponder the electromagnetic signal sent out by the RFID reader is modified with the aid of the addressed RFID transponder in such a way that enables, with the backscattered signal received by the RFID reader, an identification of an object on which the RFID transponder is arranged.

There are already methods of localizing objects with RFID systems. Methods of this type are described for example in DE 10 2012 307 424 A1 and M. Scherhäufle et al., “Indoor Localization of Passive UHF RFID Tags Based on Phase-of-Arrival Evaluation” in IEEE Transaction on Microwave Theory and Techniques, Volume 61, no. 12, pages 4724 to 4729, December 2013.

Conventional radar systems, such as for example traditional FMCW radar systems, can also be used for classifying and identifying objects. However these systems use very complex methods for identifying objects, or statistical methods that are very processing-intensive and susceptible to errors. Additionally methods based on machine-learning or artificial intelligence are frequently proposed for such applications.

For localizing with the aid of radar systems so-called MIMO radar systems with multiple send and receive channels are employed. To some extent these radar systems are also operated using transponders with modulated backscattering as a target, to increase the detection rate.

The object is therefore to develop a method and a device for a combined determination of identification information and also kinematic information about an object.

This object is achieved by a system for identification and localization of an object according to claim 1 and a method for identification and localization of an object according to claim 9.

The inventive system for identification and localization of an object comprises a bistatic FMCW radar sensor system with at least two FMCW radar sensors, which is designed to be able to be operated fully coherently or quasi-coherently and is designed to emit a series of repeating ramp signals.

A fully coherent operating mode should be understood to mean that the at least two FMCW radar sensors are precisely synchronized with each other. For this a corresponding synchronization signal is provided for each of the FMCW radar sensors, preferably via a cable link. Wire-conducted transmission of the synchronization signal is suitable in particular for high-frequency radar systems where, due to the high frequency, even small time-shifts between the individual sensors need to be avoided to achieve sufficient measurement accuracy. High-frequency radar systems should be understood to mean radar systems that can measure distances with accuracies of a few centimeters, preferably in the GHz region, that is to say less than 30 centimeters, and particularly preferably less than 3 cm. The at least two radar sensors are arranged at a known, preferably constant, distance d from each other. For example the radar sensors are located on one and the same item, for example a vehicle or an infrastructure object. If the distance d is constant or at least known, then it can be used for triangulation of the at least two sensors with a target object to be detected.

FMCW radar sensors use a so-called Frequency-Modulated Continuous Wave radar, which emits a continuous transmit signal. Such FMCW radar can change its operating frequency during a measurement, i.e. the transmit signal is frequency-modulated, for example, by generating a frequency ramp, that is to say a signal with a frequency increasing in a linear manner up to a peak value value. These changes in the frequency make transit time measurements possible. With an FMCW sensor distances can be measured precisely. In addition the distance and the radial velocity can be measured simultaneously.

Part of the inventive system for identification and localization of an object is also an active RFID transponder, which is arranged on an object to be identified and localized. The active RFID transponder is set up to generate a modulated bistatic or monostatic backscatter signal. In this regard a ramp signal sent out by one of the at least two radar sensors at a ramp repetition frequency is modulated with an amplitude modulation signal, the modulation frequency of which is already known and is less than half the ramp repetition frequency, by the active RFID transponder. A ramp repetition frequency should be understood in this context to mean the frequency at which the frequency ramps of the radar sensor are repeated. It should be noted that, with the inventive system, not only a bistatic measurement but also a monostatic measurement takes place, to determine a kinematic variable. A bistatic measurement is a measurement in which a first radar sensor emits a radar sensor signal, the radar sensor signal is reflected by an object, and then captured by a second radar sensor. A monostatic sensor signal on the other hand is a radar sensor signal, which is emitted and captured by one and the same radar sensor. Kinematic variables should be understood in this context to mean in particular position, distance, velocity, vectorial velocity, etc.

The inventive system for identification and localization of an object comprises an evaluation unit, which is set up to establish an association between a beat frequency and the modulation frequency of the active RFID transponder, which modulation frequency is already known, on the basis of the modulated bistatic backscatter signal by means of two Fourier transforms of the modulated backscatter signal, specifically a first Fourier transform according to the frequency and a second Fourier transform according to the amplitude. The two Fourier transforms are performed one after the other. In this regard the second Fourier transform is performed on the amplitude spectrum of the result of the first Fourier transform. Advantageously both a kinematic variable, such as for example a position, a distance, or a velocity of an object, and also the identification information of the object, is determined with one measurement, as it were simultaneously or in combination. The system described can be designed as a fully coherent measurement system. Particularly advantageously the described system can also be designed as a quasi-coherent measuring system if an object with a known position is equipped with an active RFID transponder as a reference. Full synchronization of the at least two FMCW radar sensors is not necessary in this case. The quasi-coherent layout is consequently advantageous in particular in the case of large distances d between the sensors, where a sufficiently precise coherence can only be established with difficulty. Modulation of the RFID transponder with a frequency, which is less than half the ramp repetition frequency of the cooperative radar system, satisfies the Nyquist Shannon theorem and permits sampling of the transponder signal across multiple frequency ramps. Due to the characteristic behavior of the amplitude spectrum at the modulation frequency of the RFID transponder, a peak value in the beat spectrum can be assigned unambiguously to a defined transponder. Therefore a multiplicity of RFID transponders can also be identified, distinguished from each other, and used for defining position or for determining kinematic variables. Furthermore the inventive system enables the measurement of vectorial velocity and direction of movement, and also the identification of an object, with just one single measurement cycle or with one single cooperative radar sensor system.

In the inventive method for identification and localization of an object a series of repeating ramp signals is emitted by means of a bistatic FMCW radar sensor system with at least two FMCW radar sensors, which is designed to be able to be operated coherently or quasi-coherently. Furthermore a modulated bistatic backscatter signal is generated by means of an active RFID transponder, which is arranged on an object to be identified and localized. In this regard a ramp signal sent out by one of the at least two radar sensors at a ramp repetition frequency is modulated with an amplitude modulation signal, the modulation frequency of which is already known and is less than half the ramp repetition frequency. Lastly an association is made between a beat frequency and the modulation frequency of the active RFID transponder, which modulation frequency is already known, on the basis of the modulated bistatic backscatter signal by means of two Fourier transforms, a first Fourier transform of the modulated backscatter signal according to the frequency and a second Fourier transform according to the amplitude. The inventive method for identification and localization of an object shares the advantages of the inventive system for identification and localization of an object.

With regard to determining the kinematic variables on the basis of the beat spectrum by means of a cooperative or quasi-cooperative radar sensor system, reference is made to DE 10 2019 206 806, which in this respect is included in its entirety in the present application text.

A number of components of the inventive system can be designed for the most part in the form of software components. This relates in particular to parts of the system for identification and localization of an object, such as the evaluation unit, for example.

Essentially however these components can also be partly implemented in the form of software-supported hardware, for example FPGAs or similar, in particular where particularly fast calculations are involved. Likewise the necessary interfaces can be designed in the form of software interfaces, for example where just the importing of data from other software components is involved. However they can also be designed in the form of interfaces constructed with hardware, which are activated by suitable software.

A largely software-based implementation has the advantage that computer systems already previously present in a mobile object or in infrastructure can also be simply upgraded to work in the inventive manner, after possible supplementation with additional hardware elements, such as an RFID transponder and FMCW radar sensors and also units for synchronizing and triggering sensor signals for example, by means of a software update. To this extent the object is also achieved by means of a corresponding computer program product with a computer program, which can be loaded directly into a memory facility of such a computer system, with program sections to execute those steps of the inventive method that can be implemented by software, when the computer program is executed in the computer system.

Aside from the computer program, such a computer program product can also comprise where appropriate additional elements, such as e.g. documentation and/or additional components, including hardware components, such as e.g. hardware keys (dongles etc.) for using the software.

With regard to transport to the memory facility in the computer system and/or for storage on the computer system it is possible to use a computer-readable medium, for example a memory stick, a hard drive, or some other transportable or permanently installed data carrier, on which are stored the program sections of the computer program that can be read in and executed by a computer unit. For this the computer unit can have e.g. one or more interoperating microprocessors or similar.

The dependent claims and also the following description each contain particularly advantageous embodiments and developments of the invention. In this regard in particular the claims of one claim category can also be developed analogously to the dependent claims of another claim category and its description parts. Additionally even the various features of different exemplary embodiments and claims can also be combined to form new exemplary embodiments in the context of the invention.

In a variant of the inventive beat frequency measurement method the at least two radar sensors are operated fully coherently by means of a common clock. Fully coherent operation should be understood in this context to mean that the at least two radar sensors are synchronized by means of a clock signal. Fully coherent operation does not result in frequency shifts in the bistatic region of the determined beat spectrum, so that correction of the measured beat spectrum with the aid of a reference target is not necessary. Such a solution is advantageous in particular in the case of sensors arranged on mobile units, since the sensors are moved with the said mobile units, and distances to reference objects are may not always be precisely known.

Alternatively, the at least two sensors can be operated quasi-coherently by means of additional monostatic and bistatic measurement of a reference target whose position is known. In quasi-coherent operation there is no common clock timing of the at least two sensors. Shifts in the beat spectrum are compensated for by measuring the distance to a reference object. This procedure is advantageous in the case of a stationary arrangement of sensors, for example on elements of traffic or street infrastructure. In that case distances to possible reference objects are known. Common clock timing of the sensors can be omitted here.

In detail, in the case of a quasi-coherent measurement, a calibration takes place to determine a corrected beat spectrum. To do this a frequency of the reference target in the bistatic region is determined on the basis of the determined raw data beat spectrum. A value f_{diff} of a frequency shift of the beat spectrum in the bistatic region is determined on the basis of the frequency of the reference target in the bistatic region determined by the measurement and an already known nominal frequency of the bistatic reflection signal of the reference target. The nominal frequency can be determined or known on the basis of an already known distance to the reference target.

Finally the raw data beat spectrum is shifted by the determined value f_{diff} of the frequency shift.

A frequency of the reference target in the bistatic region preferably corresponds to a peak value in the beat spectrum. Advantageously a frequency of a reference target can be recognized on the basis of the intensity of a spectral value.

According to the invention the reference target is an active reference target, preferably an active RFID transponder, which is illuminated with the aid of an active sensor, and which modulates the waves emitted by the sensor and then sends them off in the direction of the radar sensors.

Such an active reference target comprises a transmit/receive antenna, with which waves emitted by an active sensor are received, optionally amplified and modulated, and sent out again. Reliable recognition and identification of the reference target can be achieved with such a reference target since it can be characterized by a specific modulation.

In an embodiment of the inventive system for identification and localization of an object the evaluation unit is set up to determine a distance of the active reference target, preferably an active RFID transponder, to the bistatic radar sensor system on the basis of the beat frequency, and to identify the active reference target on the basis of the already known modulation frequency. Advantageously simultaneous identification and localization of an object is made possible, where one and the same sensor technology can be employed to obtain both pieces of information. This simplifies construction of the overall system.

In an advantageous variant of the inventive system for identification and localization of an object the system comprises, in the case of a quasi-coherent bistatic radar sensor system, a reference target with already known position and an active RFID transponder with already known modulation frequency. In this variant the evaluation unit is set up to assign a beat frequency to the reference target on the basis of the two Fourier transforms and the already known modulation frequency of the reference target. Additionally the inventive system for identification and localization of an object further comprises a calibration unit, which is set up to carry out a calibration to determine a corrected beat spectrum on the basis of a monostatic measurement with one of the at least two radar sensors and on the basis of the determined beat frequency of the reference target. Advantageously a lack of coherence in the system can be corrected by the calibration.

The calibration unit is preferably set up to determine a frequency of the reference target in the bistatic region on the basis of the determined beat spectrum, determine a value of a frequency shift of the beat spectrum in the bistatic region on the basis of the frequency of the reference target in the bistatic region determined by the measurement and an already known nominal frequency of the bistatic reflection signal of the reference target, and shift the beat spectrum by the determined value of the frequency shift. Advantageously the lack of coherence of the bistatic measurement can be corrected by the bistatic measurement of a reference object.

In a special implementation, the inventive system for identification and localization of an object comprises a position determination unit, which is set up to determine a position of an active RFID transponder on the basis of the assigned beat frequency. To do this a first transit time of the monostatic reflection signal is determined on the basis of the frequency of the target object in the monostatic region of the determined beat spectrum. Furthermore, a second transit time of the bistatic reflection signal is determined on the basis of the frequency of the target object in the bistatic region of the determined beat spectrum. Distances of the sensors to the target object are determined on the basis of the determined transit times. Finally a position of the target object is determined by triangulation on the basis of the determined distances.

The inventive system can also have a velocity determination unit, which is set up to determine a first Doppler frequency of the monostatic reflection signal of the target object in the monostatic region of the determined beat spectrum, a second Doppler frequency of the bistatic reflection signal of the target object in the bistatic region of the determined beat spectrum, a first velocity component of the target object on the basis of the first Doppler frequency, a second velocity component of the target object on the basis of the second Doppler frequency and the first velocity component, and to determine a vectorial velocity of the target object on the basis of the determined first velocity component and the determined second velocity component. Advantageously the measurement values captured by the inventive system can also be used for determining a vectorial velocity of a detected object. In this way a movement of an object in two or three dimensions can be estimated.

Particularly preferably the inventive system for identification and localization of an object comprises a multiplicity of RFID transponders, each of which has a different modulation frequency and each of which is arranged on a different object. Advantageously a multiplicity of objects can be distinguished from each other and identified.

The inventive system can also have a multiplicity of RFID transponders, which are arranged on one and the same object such that the length and/or width and/or height of the object can be estimated with the aid of the transponders.

Additionally the intrinsic rotation of an object can be determined with multiple such transponders on one object and with the aid of the velocity information from the transponders.

Determination of the dimensions or rotation can be used in production operations for automated processing.

The invention is explained again in detail below by reference to the enclosed figures on the basis of exemplary embodiments. These show:

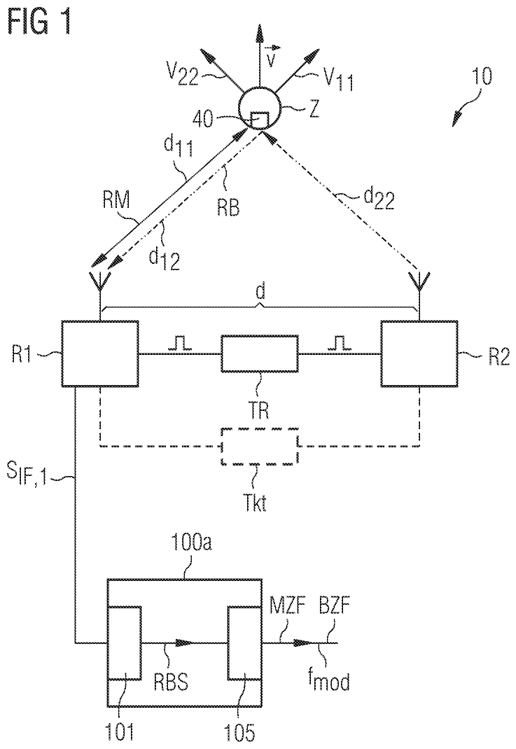

FIG. 1—A schematic representation of a fully coherent cooperative radar system according to an exemplary embodiment of the invention,

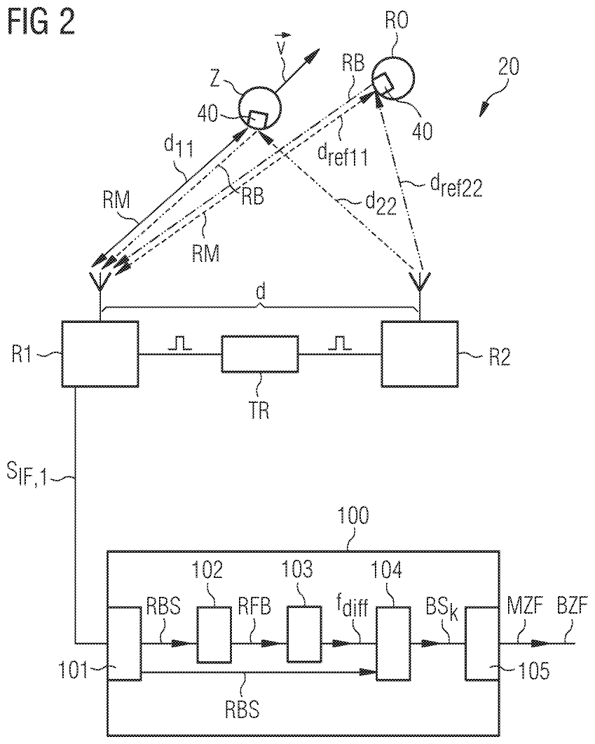

FIG. 2—A schematic representation of a quasi-coherent cooperative radar system according to an exemplary embodiment of the invention,

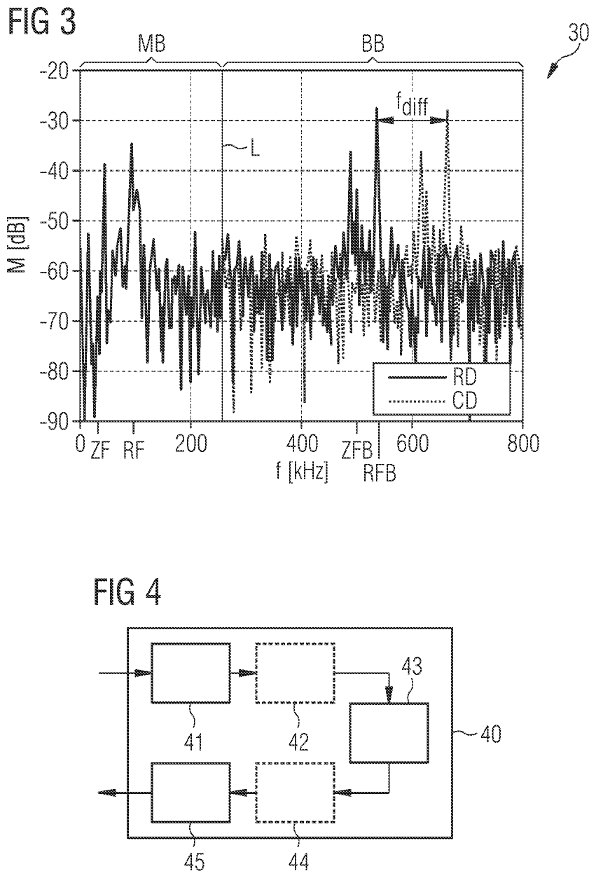

FIG. 3—A schematic representation of a beat spectrum of a quasi-coherent cooperative radar system according to an exemplary embodiment of the invention,

FIG. 4—A schematic representation of an active RFID transponder according to an exemplary embodiment of the invention,

FIG. 5—A graph illustrating the profile of the sensor signals generated by the radar sensor and also of the modulation signal,

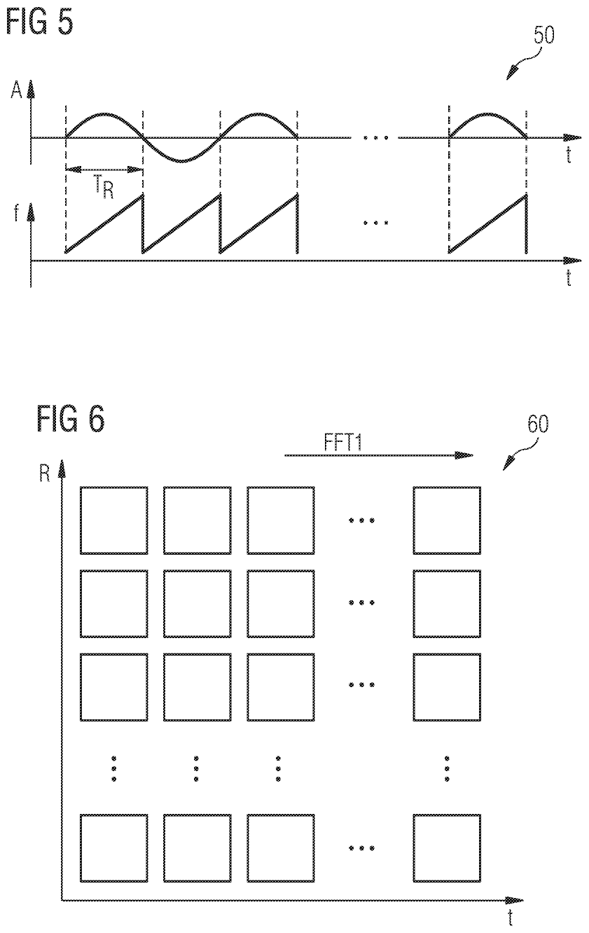

FIG. 6—A schematic representation of the first Fourier transform,

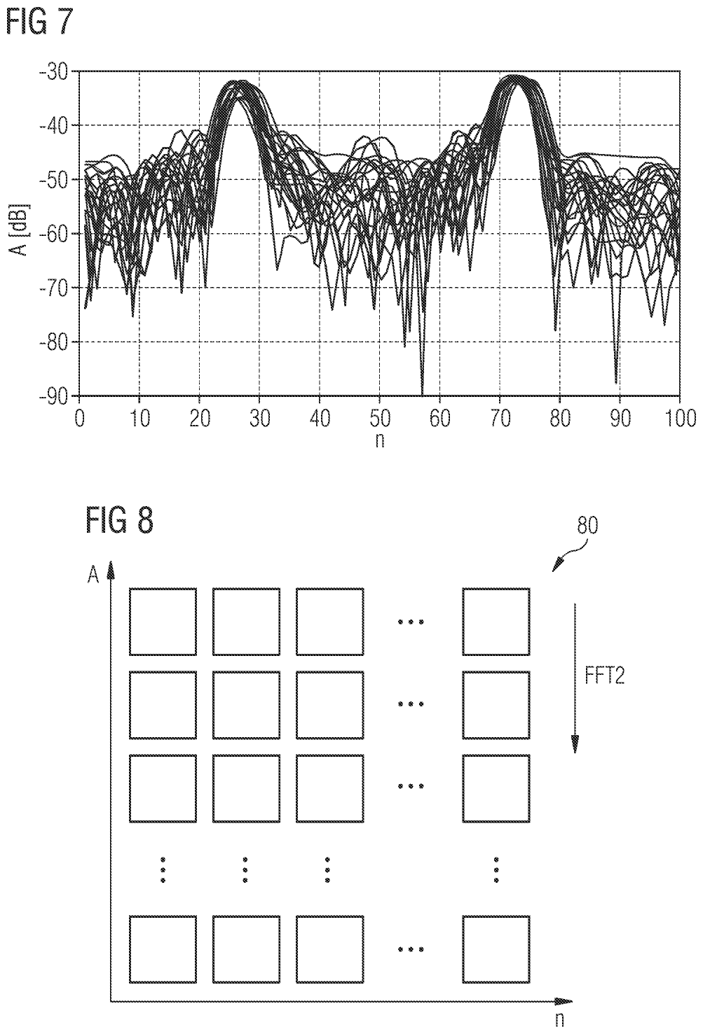

FIG. 7—A graph of a plurality of superimposed and shifted beat spectra of a quasi-coherent cooperative radar system according to an exemplary embodiment of the invention,

FIG. 8—A schematic representation of the second Fourier transform,

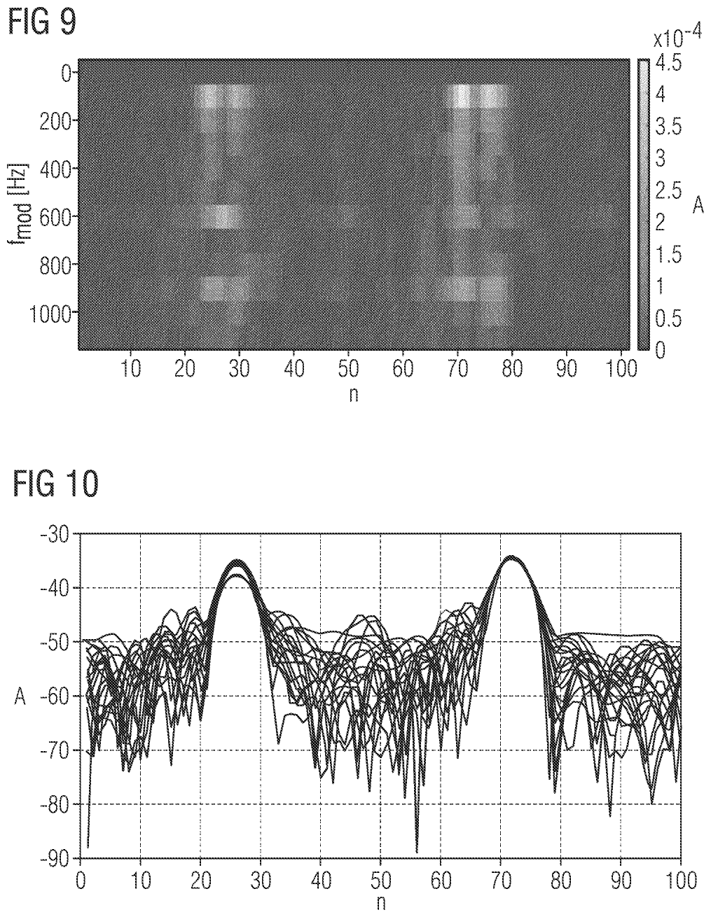

FIG. 9—A schematic representation of the signal amplitude as a function of the carrier frequency and of the modulation frequency,

FIG. 10—A representation of a corrected beat spectrum of the superimposed beat spectra,

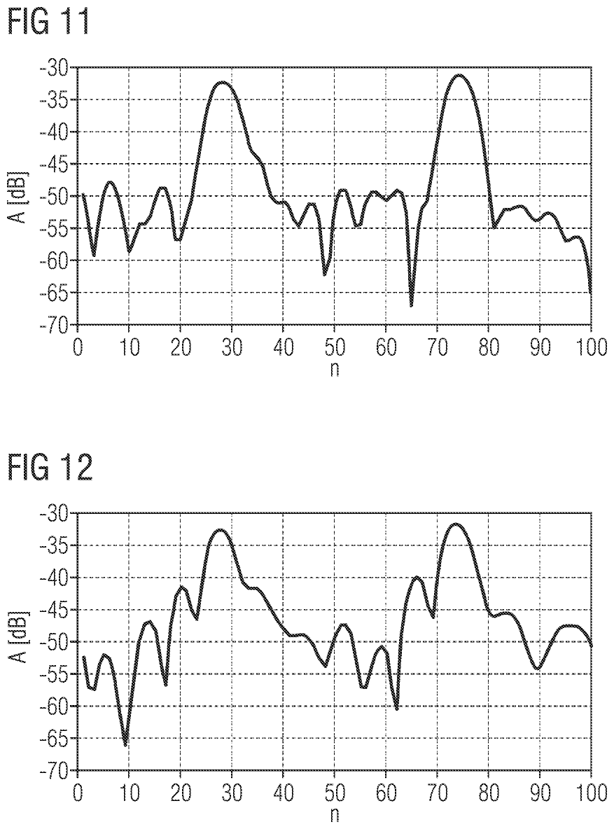

FIG. 11—A graph representing a first beat spectrum individually,

FIG. 12—A graph illustrating a second beat spectrum,

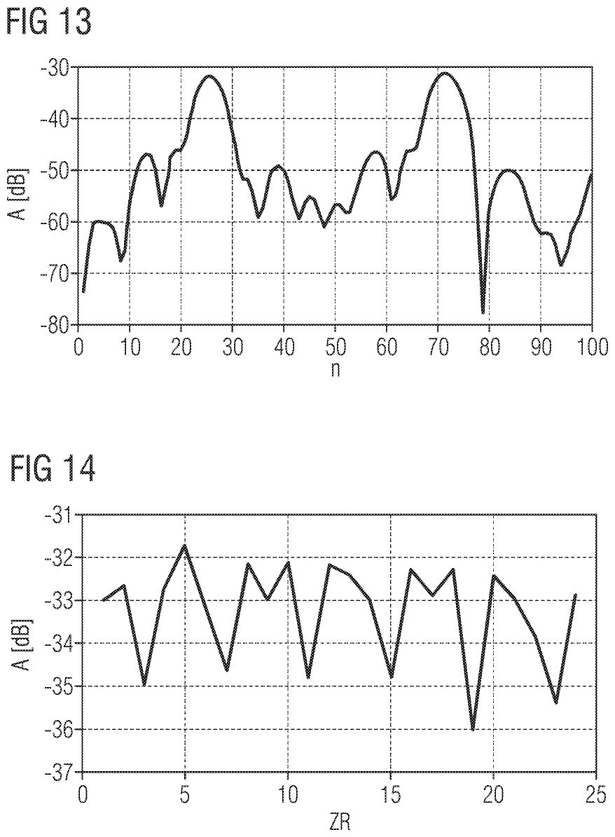

FIG. 13—A graph illustrating the 24th beat spectrum,

FIG. 14—A graph illustrating a time-based amplitude profile of a carrier frequency as a function of successive ramp signals,

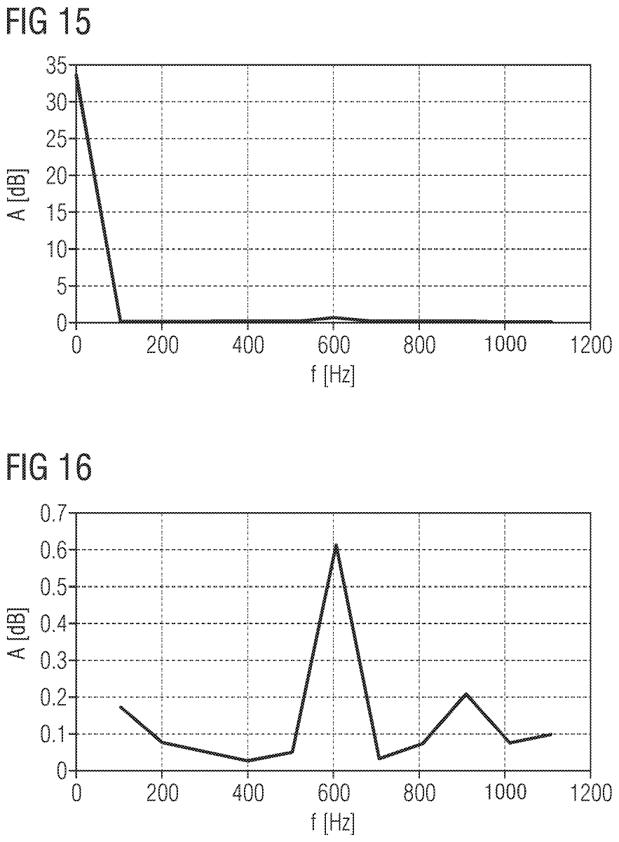

FIG. 15—A graph showing an amplitude spectrum as a function of the modulation frequency,

FIG. 16—A graph showing the amplitude spectrum shown in FIG. 15 corrected by the DC value,

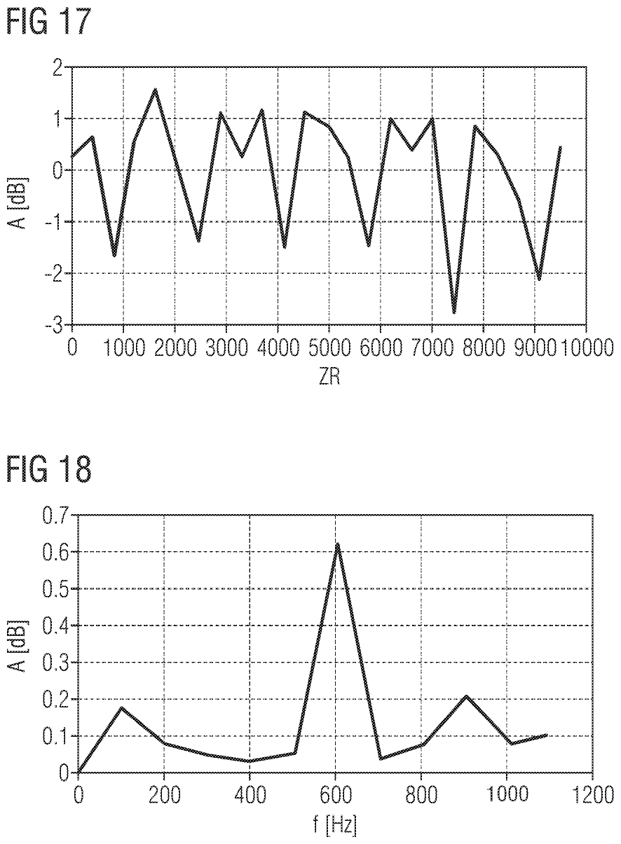

FIG. 17—A graph illustrating the profile of the receive signal for bin 27 stripped of the average value,

FIG. 18—A graph showing the Fourier transform “in amplitude direction” for bin 27,

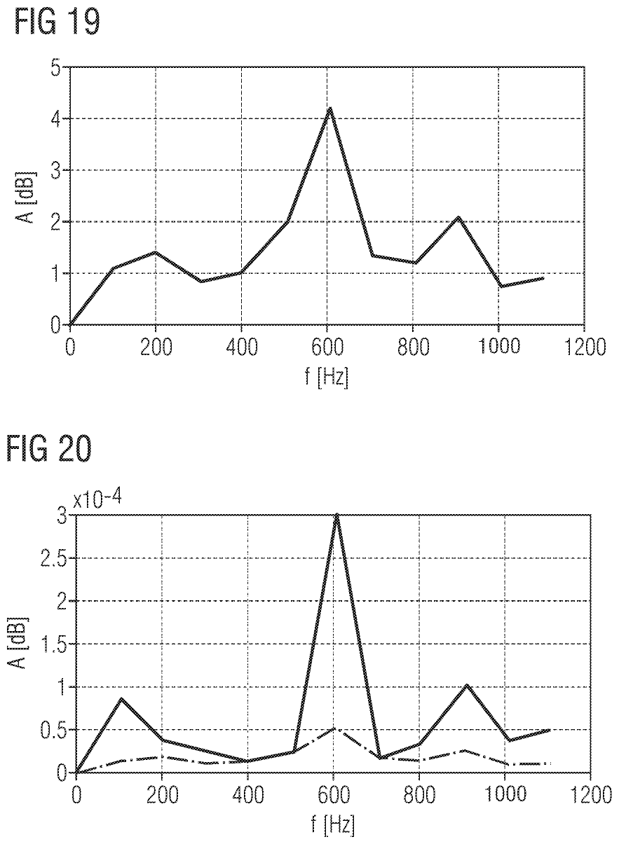

FIG. 19—A graph showing the Fourier transform in amplitude direction for frequency bin 49,

FIG. 20—A graph illustrating a comparison of the two Fourier transforms in amplitude direction, weighted with the receive power of the bin, for frequency bin 27 and 49,

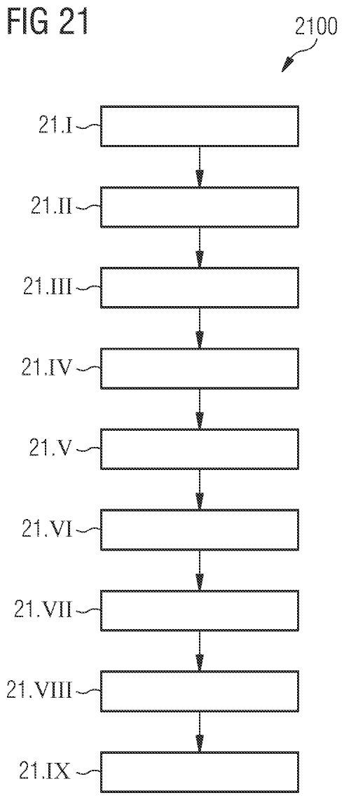

FIG. 21—A flowchart illustrating a combined identification and position determination method according to an exemplary embodiment of the invention.

FIG. 1 illustrates a schematic representation of a cooperative fully coherent radar system 10. The radar system 10 comprises a first radar sensor R1 and a second radar sensor R2 positioned at a distance from the first radar sensor R1. The two sensors R1, R2, which perform measurements in different spatial directions, are combined to form one cooperative radar system. The radar sensors R1, R2 are designed as conventional stand-alone FMCW radar sensors and each measure a monostatic response of a target Z, i.e. a monostatic reflection signal RM, which can be used for determining the distances d₁₁, d₂₂ between the radar sensors R1, R2 and the target object Z, and also the velocity of the target Z. Furthermore the target has an RFID transponder 40, which modulates a signal from the radar sensors with a modulation signal with the frequency f_{mod}, which is smaller than half the ramp repetition frequency of the radar sensors R1, R2. In addition to the monostatic response a bistatic reflection signal RB can also be measured by the two radar sensors R1, R2. The bistatic reflection signal RB contains information relating to the distance in the radial direction from the sensor R2 to the target Z and in the direction from the radar sensor R1 to the target Z, and also information relating to the velocity of the target object Z.

In the first exemplary embodiment shown in FIG. 1 the two sensors R1, R2 are synchronized by means of a clock signal generator Tkt, i.e. the two radar sensors R1, R2 are operated fully coherently by means of a common clock. This type of fully coherent operation can be advantageous in an autonomous vehicle for example.

Transmission of the clock signal from the clock signal generator to the radar sensors R1, R2 can be implemented for example via an electric cable connection between the two radar sensors and the clock signal generator Tkt.

With the aid of the monostatic response it is possible to determine from the bistatic response the respective distance d₁₁, d₂₂ from the spatial direction from the two sensors R1, R2 to the target Z, and the velocity. Because the two sensors R1, R2 are set up at spatially distributed points a localization and a vectorial velocity measurement of objects Z is possible in such a cooperative radar system. Furthermore a distance d₁₂, which the bistatic signal travels from the sensor R2 via the target Z to the sensor R1, is also drawn in. Only the measurement data from just one of the two sensors R1, R2 is needed to obtain this information.

The two sensor R1, R2 start a measurement by means of a common trigger signal from the trigger unit TR, which is connected to the two sensors R1, R2 either via a cable or by radio link. The common trigger signal ensures that the bistatic response can be measured within the limits set by the sensor hardware and software, i.e. in particular limits for the beat frequency bandwidth, the ramp configuration, and the A-D converter.

To distinguish between the monostatic response and the bistatic response at the first sensor R1, a frequency offset is implemented between the two radar sensors R1, R2, i.e. the FMCW signals of the first and the second radar sensors R1, R2 each start at different frequencies f_{0,1}, f_{0,2}. The bandwidth B and the duration T of the FMCW signal is the same for both sensors R1, R2. As a result the bistatic response is shifted by the frequency offset f_{off}=f_{0,1}−f_{0,2} to a predefined region in the baseband and can be separated from the monostatic response.

The beat signal S_{IF,1} of the first radar sensor R1 is related to the transit times τ₁₁, τ₁₂, of the monostatic reflection signal and the bistatic reflection signal as follows:

$${S}_{IF , 1} = {S}_{IF , 1 , m o n o} + {S}_{IF , 1 , bi} = cos ( 2 π ( \frac{B}{T} {τ}_{11} t + {f}_{0 , 1} {τ}_{11} - \frac{B}{2 T} {τ}_{11}^{2} ) ) + cos ( 2 π ( ( {f}_{0 , 1} - {f}_{0 , 2} ) t + \frac{B}{T} {τ}_{12} t + {f}_{0 , 2} {τ}_{12} - \frac{B}{2 T} {τ}_{12}^{2} ) + {∅}_{0 , 1} - {∅}_{0 , 2} ) . \qquad ( 1 )$$

The signal S_{IF,1} comprises a monostatic component S_{IF,1}, mono and a bistatic component which is attributable to the interaction between the second sensor R2, the target object Z, and the first sensor R1. The terms

$$\frac{B}{T} {τ}_{11} t , \frac{B}{T} {τ}_{12} t$$

behave proportionally to the distance of the target Z. The times τ₁₁ and τ₁₂ designate the transit times of the monostatic and bistatic signals S_{IF,1,mono}, S_{IF,1,bi}. The two phase values ϕ_{0,1}, ϕ_{0,2} are the phases of the two sensor signals, the difference between which is known on the basis of the common clock timing.

Part of the beat spectrum measurement facility 10 shown in FIG. 1 is also an evaluation unit 100a with a spectrum determination unit 101 for determining a raw data beat spectrum RBS on the basis of the captured measurement data S_{IF,1}. The raw data beat spectrum RBS has a low-frequency monostatic region MB, which is assigned to the monostatic reflection signal RM, and a higher-frequency bistatic region BB, which is assigned to the bistatic reflection signal RB.

Finally, on the basis of the raw data beat spectrum RBS, a monostatic beat frequency MZF and a bistatic beat frequency BZF of the target object Z are determined by a beat frequency determination unit 105.

Based on these beat frequencies and also the known bandwidth B of the signal and the signal duration T, it is possible to determine the transit times τ₁₁, τ₁₂ of the monostatic reflection signal and the bistatic reflection signal.

The distance d₁₁ between the first sensor R1 and the target object Z can be calculated from the transit time τ₁₁ of the monostatic signal S_{IF,1,mono} by using the following equation:

$${τ}_{11} = 2 \cdot \frac{{d}_{11}}{c} . \qquad ( 2 )$$

where c is the speed of light or the propagation velocity of the radar waves.

From the transit time τ₁₂ of the bistatic signal S_{IF,1,bi} and also the value d₁₁ determined for the distance between the first sensor R1 and the target object Z it is possible to calculate the distance d₂₂ between the second sensor R2 and the target object Z by means of the following equation:

$${τ}_{12} = \frac{{d}_{11} + {d}_{22}}{c} . \qquad ( 3 )$$

Using a simple trigonometric calculation based on the thus known sides of the triangle d, d₁₁, d₂₂ the position P of the target object Z relative to the radar system 10 can then be determined.

The velocity v=v₁₁+v₂₂, where v, v₁₁, v₂₂ are each vectorial variables and v₁₁ points in the direction of d₁₁ and v₂₂ in the direction of d₂₂, results from the Doppler frequencies of the monostatic and bistatic sensor signals S_{IF,1,mono}, S_{IF,1,bi}.

The Doppler frequency arises from the difference between the frequency of an emitted signal and the frequency of the reflected signal. Additionally the Doppler frequency can be calculated with the aid of multiple successive signals with a timing interval T. In this regard the Doppler frequency is given by the phase difference between the individual signals at the respective beat frequency of the target object.

The Doppler frequency can be calculated in various ways. In the case of static targets the phase of the beat signal is constant for signals that are consecutive in time. In the case of moving objects the phase of the beat signal changes with signals that are consecutive in time in proportion to the change in the distance and therefore in proportion to the velocity.

This change in the phase over time produces the Doppler frequency. This method is also designated as “Range Doppler Algorithm” or “Range Doppler Processing”.

The Doppler frequency fa, mono of the monostatic signal component is given by the following:

$${f}_{d , m o n o} = \frac{2 {f}_{0 , 1} {v}_{11}}{c} . \qquad ( 4 )$$

If the transit time Iii of the monostatic signal is known then the velocity vu, i.e. the velocity component of the target object Z in the direction of the path between the first sensor R1 and the target object Z, can be determined from the Doppler frequency f_{d,mono}.

The Doppler frequency f_{d,bi} of the bistatic sensor signal is given by the following:

$${f}_{d , b i} = {f}_{0 , 2} \frac{{v}_{11} + {v}_{22}}{c} . \qquad ( 5 )$$

From the bistatic Doppler frequency f_{d,bi} and also the determined velocity component v₁₁ it is then also possible to determine the second velocity component v₂₂ in the direction of the path between the second sensor R2 and the target object Z. Additionally the vectorial total velocity v of the target object Z can be calculated from the two velocity components v₁₁, v₂₂ giving:

v=v₁₁+v₂₂. (6)

The evaluation unit 100a shown in FIG. 1 is additionally set up to establish an association between a beat frequency of a bistatic signal S_{IF,1,bi} and the modulation frequency f_{mod} of the active RFID transponder 40 of the target Z, which modulation frequency is already known, on the basis of the bistatic backscatter signal modulated by the target Z by means of a first Fourier transform of the modulated backscatter signal according to the frequency f and a second Fourier transform according to the amplitude A. By determining the characteristic modulation frequency f_{mod} for the target Z or the RFID transponder attached to the target Z it is possible to determine the identity of the target Z.

FIG. 2 shows a schematic representation of a quasi-coherent cooperative radar system 20. Just like the radar system 10 represented in FIG. 1 the radar system 20 comprises a first radar sensor R1 and a second radar sensor R2 positioned at a distance d from the first radar sensor R1. Unlike the radar system 10 shown in FIG. 1 the radar system 20 represented in FIG. 2 is not a fully coherent system but a quasi-coherent system. The difference with respect to the exemplary embodiment shown in FIG. 1 consists in the fact that the system 20 shown in FIG. 2 does not have a clock signal generator Tkt for the two sensors R1, R2. Consequently the sensor signals of different sensors do not have a fixed phase relationship. Instead the two radar sensors R1, R2 are operated quasi-coherently by using a known reference target RO and by means of corresponding signal processing. In such an operation with a reference target Z the bistatic response is corrected with the aid of the known and measured distance d_{ref11} to the reference target. Alternatively a distance d_{ref22} from the reference object RO to the second sensor R2 can also be used for the correction.

The two sensors R1, R2, which make measurements in different spatial directions, are combined for form a cooperative radar system. The radar sensors R1, R2 are designed in the form of conventional stand-alone FMCW radar sensors and in each case measure a monostatic response from the target Z and from the reference target RO, i.e. a monostatic reflection signal RM, which can be used for determining the distance d₁₁, d_{ref} and also the velocity of the target Z or reference target RO in the radial spatial direction from the sensor R1 to the target Z or reference target RO. In addition to the monostatic response a bistatic reflection signal RB is also measured by the two radar sensors R1, R2 as in the case of the exemplary embodiment shown in FIG. 1.

The bistatic reflection signal contains information about the distance d₂₂ and about the velocity in the radial direction from the sensor R2 to the target Z and about the distance d₁₁ in the direction from the radar sensor R1 to the target Z. This also applies correspondingly to the reference target RO.

As in the exemplary embodiment shown in FIG. 1 the two sensors R1, R2 start a measurement by means of a common trigger signal from the trigger unit TR, which is connected to the two sensors R1, R2 either via a cable or by radio link. The common trigger signal ensures that the bistatic response can be measured within the limits set by the sensor hardware and software, i.e. in particular limits for the beat frequency bandwidth, the ramp configuration, and the ADC (Analog Digital Controller).

To distinguish between the monostatic response and the bistatic response at a sensor R1, a frequency offset is implemented between the two radar sensors R1, R2, i.e. the FMCW signals of the second radar sensors each start at different frequencies. The bandwidth and the duration of the FMCW signal is the same for both sensors R1, R2. As a result the bistatic response is displaced by the frequency offset f_{off} to a predefined region in the baseband and can be separated from the monostatic response.

Following determination of a beat spectrum a correction of the bistatic component of the beat spectrum is then carried out, unlike in the exemplary embodiment shown in FIG. 1. This process is explained in detail in conjunction with FIG. 3.

As in the procedure illustrated in FIG. 1 the corrected beat spectrum is then used to determine a position P and a velocity v of the target object Z.

As explained in conjunction with FIG. 1, with the aid of the monostatic response, the distance and the velocity in the direction from the sensor R2 to the target object Z can be determined from the bistatic response. If the two sensors R1, R2 are set up at spatially distributed points then localization and vectorial velocity measurement of objects Z is possible in such a cooperative radar system. Only the measurement data from just one of the two sensors R1, R2 is needed to obtain this information.

The quasi-coherent operation can also be implemented with the aid of a GPS-controlled system or a radio link between the individual sensors.

GPS or radio links between the sensors can replace the trigger unit TR. Both variants can be used for the triggering function in coherent and quasi-coherent operation.

In the case of GPS signals a very stabile “pulse per second” signal (GPS 1 PPS) is sent (frequency 1 Hz). This signal can be received at the sensors in the system in the case of operation outdoors and following this a trigger signal can be generated locally. This process can be implemented in each case with the aid of a dedicated phase-locked loop, which uses the 1 PPS signal as a reference signal.

A radio link between the sensors presupposes a master/slave operation between the sensors. In this regard the master sensor can send a trigger signal to the slave sensor. This can take place both within the radar frequency band used for the distance measurement, and also with additional hardware in other frequency bands. In addition frequency and phase offsets can be compensated for with the aid of a previously defined signal form, which is sent by the master to the slave, similar to a pilot tone method.

An example of synchronization with the aid of a direct radio link between two radar sensors is given in the paper “Precise Distance Measurement with Cooperative FMCW Radar Units” by A. Stelzer, M. Jahn and S. Scheiblhofer, 1-4244-1463-6/08/$25.00 2008 IEEE, p. 771 to 774. However only the distance between the sensors is measured in this case.

Part of the beat spectrum measurement facility 20 shown in FIG. 2 is also an evaluation unit 100 with a spectrum determination unit 101 for determining a raw data beat spectrum RBS on the basis of the captured measurement data S_{IF,1}. The raw data beat spectrum RBS has a low-frequency monostatic region MB, which is assigned to the monostatic reflection signal RM, and a higher-frequency bistatic region BB, which is assigned to the bistatic reflection signal RB. The raw data beat spectrum RBS is transmitted to a reference frequency determination unit 102, which is set up to determine a frequency or beat frequency RF of the reference target RO in the bistatic region BB on the basis of the determined raw data beat spectrum RBS. The frequency RFB of the reference target RO is transmitted to a shift frequency determination unit 103, which is set up to determine a value f_{diff} for a frequency shift of the beat spectrum in the bistatic region on the basis of the frequency RFB of the reference target in the bistatic region as determined by the measurement and a previously known nominal frequency SFB of the bistatic reflection signal of the reference target RO.

The value f_{diff} for the frequency shift and the raw data beat spectrum RBS are transmitted to a shift unit 104. The shift unit is used to shift the bistatic component of the raw data beat spectrum RBS by the value determined for the frequency shift f_{diff}. In the course of this process a corrected beat spectrum BSₖ is determined, which can be used as the basis for a position calculation and a velocity calculation.

Finally, on the basis of the corrected beat spectrum BSₖ, a monostatic beat frequency MZF and a bistatic beat frequency BZF is determined for the target object Z by a beat frequency determination unit 105.

The evaluation unit 100 shown in FIG. 2 is additionally set up to establish an association between a beat frequency of a bistatic signal S_{IF,1,bi} and the already known modulation frequency f_{mod} of the active RFID transponder of the target Z, on the basis of the bistatic backscatter signal modulated by the target Z by means of a first Fourier transform of the modulated backscatter signal according to the frequency f and a second Fourier transform according to the amplitude A. By determining the characteristic modulation frequency f_{mod} for the target Z or the RFID transponder 40 attached to the target Z it is possible to determine the identity of the target Z.

FIG. 3 shows a graph 30, which illustrates a so-called beat spectrum BS of a measurement with the arrangement 20 shown in FIG. 2. The beat spectrum shown in FIG. 3 was thus recorded in quasi-coherent operation. It shows the quantity M in decibels plotted against the frequency f in Hertz.

During the measurement there was no full synchronization of the two radar sensors R1, R2 by means of a clock signal Tkt. Instead, a monostatic reflection signal MR and a bistatic reflection signal BR were measured both from the target object Z and also a reference target RO. In the beat spectrum the monostatic region MB and the bistatic region BB are separated from each other by means of a vertical black line L, which is situated approximately at a frequency of 250 kHz. Peak values RF, ZF, which correspond to the reference target RO and the target object Z, are plotted in the monostatic region. The frequency ZF, which corresponds to the target object, is situated at approximately 50 kHz, and the frequency RF, which corresponds to the reference target RO, is situated at approximately 100 kHz.

Peak values RFB, ZFB, which correspond to the reference target and the target object, can also be seen in the bistatic region BB of the beat spectrum BS. The frequency ZFB, which corresponds to the target object Z, is situated at approximately 530 kHz ad the frequency RFB, which corresponds to the reference target RO, is situated at approximately 570 kHz. The solid line indicates the raw data RD of the radar sensor R1, i.e. the data which has not yet been corrected with the aid of the reference target RO. A correction of the beat spectrum BS in the bistatic region BB results in the two target objects being shifted to the right in the beat spectrum. This process is possible on the basis of the known position of the reference target ZO and a likewise known beat frequency assigned to its distance away, in this case at about 660 kHz. The shifted spectrum CD is indicated by a dotted line. With the aid of the corrected spectral data CD the distance d₂₂ between the second radar sensor R2 and the target ZO can be determined. Once the distances d₁₁, d₂₂ between the radar sensors R1, R2 and the target are known the unknown target can then be localized by means of triangulation, i.e. its position defined. Furthermore by defining the Doppler frequency the vectorial velocity of the target object Z can be determined. Monostatic and bistatic responses are evaluated for determination of both variables. These provide distance values or velocity values in two spatial directions.

FIG. 4 illustrates an active RFID transponder 40 of a system according to an exemplary embodiment of the invention. Such an active RFID transponder 40 can be arranged both on a reference object with known position and also on a large number of objects to be detected and to be identified by an autonomous system, for example a vehicle or a robot. The RFID transponder 40 comprises an antenna 41, by means of which a radar signal is received from one of the radar sensors in the co-operative radar system. Part of the RFID transponder 40 is also a first amplifier 42, with which the incoming radar signal is amplified. The radar signal is transmitted by the first amplifier 42 to a modulator 43, which performs an amplitude modulation on the radar signal with a sine-wave oscillation at a modulation frequency of f_{mod}. In this regard the modulation frequency (no frequency modulation is performed, but instead an amplitude modulation: the modulation frequency is the frequency of the variation in the amplitude in this case) is less than half the so-called ramp repetition frequency f_{R}. The ramp repetition frequency f_{R} is the frequency with which the frequency ramp of the FMCW radar sensor in the cooperative radar system is repeated. Therefore the ramp repetition frequency is at least twice as much as the modulation frequency f_{mod}. The amplitude-modulated signal is then amplified by a second amplifier 44 and sent out by the RFID transponder 40 via a transmit antenna 45.

FIG. 5 shows a diagram 50, which compares the frequency ramps f of the radar sensor with the amplitude values A of the modulation signal. As can be seen the frequency of the modulation signal is two times as much as the ramp repetition frequency f_{R}. The Nyquist Shannon theorem is therefore satisfied. Multiple ramps are sent out successively in time by each radar sensor for each measurement, i.e. the frequency of the radar signal sent out by a radar sensor is increased in a linear manner over time, until a peak frequency is reached after a period TR. Subsequently the radar signal is emitted with the minimum frequency, after which the frequency of the radar signal is again increased in a linear manner over time etc. All the ramp signals are amplitude-modulated by the RFID transponder 40 (see FIG. 4) and the modulated signal is sent back to the respective sensor of the cooperative system (see FIG. 1, 2). In the evaluation unit of the cooperative radar systems the modulated radar signals are mixed down to a beat frequency Δf dependent on the distance of the transponder 40. In other words the radar signal is mixed with the frequency f₁ of the receiving radar sensor, where the difference result gives the signal with the beat frequency of the RFID transponder dependent on the distance of the transponder. Due to the amplitude modulation a Fourier transform of the modulated radar signal then produces a different amplitude for each ramp at the captured beat frequency.

In FIG. 6 sampling values for a multiplicity of N ramps R for calculating an amplitude spectrum with the aid of a first Fourier transform FFT1 are shown in the form of empty squares. An amplitude spectrum of this type is illustrated in FIG. 7 for a multiplicity of ramps or signals. In the first Fourier transform FFT1 the received modulated radar signal is sampled at constant time intervals over the time t. To illustrate this better FIG. 6 makes clear a “direction” of the sampling for the first Fourier transform FFT1 by means of an arrow indicating the sampling direction from left to right. In this regard it should be noted that the signals assigned to individual ramps in FIG. 6 are indeed symbolized among themselves by means of rows, but in reality they are captured consecutively in time. The sampling takes place therefore row by row from left to right and in sequence from top to bottom.

FIG. 7 represents the amplitude spectrum for a total of 24 signals generated by the first Fourier transform FFT1. The ordinate shows so-called frequency bins n from the value n=1 to 100. In each case a frequency interval is assigned to the individual frequency bins. FIG. 7 shows only the bistatic component of the amplitude spectrum, that is to say the component generated by the cooperative deployment of two radar sensors. As can be seen in FIG. 7, the amplitude spectrum does not yet show an unambiguous peak value for all signals, since the signals were only generated and captured in a quasi-coherent manner. The frequency of the nth bin is:

fₙ=fₛₐₘₚₗₑ/N_{Abtast}*n. (7)

Here fₛₐₘₚₗₑ is the peak value sampling frequency and N_{abtast} the quantity of samplings for the Fourier transform. The value n indicates the number of the nth bin. The frequency fₙ is the respective right boundary frequency of the nth bin.

FIG. 8 illustrates a second Fourier transform FFT2 along the individual amplitude values A across all ramps for a frequency. One frequency or one frequency interval corresponds to one bin n. The direction of the sampling to generate the Fourier transform is illustrated in FIG. 8 as a vertical arrow pointing from top to bottom, i.e. the sampling takes place in the amplitude direction. The second Fourier transform FFT2 is used to find the beat frequency of the RFID transponder. In this regard the amplitude varies for each ramp and the same beat frequency or the same bin n. If the second Fourier transform is then constructed for each bin n in the amplitude direction, then the diagram illustrated in FIG. 9 is produced.

FIG. 9 shows a diagram of the second Fourier transform. The second Fourier transform shows a spectrum as a function of the beat frequency or the corresponding bins n and also the modulation frequency f_{mod}. Bright regions in the graph represent peak values in the amplitude A. If the modulation frequency of 600 Hz is known, as is the case for a reference target RO for example, then the peak value for bin 27 can be read off from the graph. In this way the bistatic beat frequency (corresponding to bin 27) of the reference target can be defined. If the bistatic beat frequency of the reference target RO is then known, a shift of the individual peak values in the graph in FIG. 7 to bin 27 can be carried out. In this way a corrected beat spectrum is obtained, as shown in FIG. 10.

FIG. 10 then shows the corrected beat spectrum. In the corrected beat spectrum the peak values of the individual signals are each arranged at the same frequency. While the left peak value represents the reference target, a second peak value occurs in the right section of the beat spectrum, which is attributable to an object whose beat frequency is situated at bin 72. On the basis of the beat frequency the position and also the velocity of the detected object can then be determined. If therefore, instead of one transponder, multiple transponders are distributed on various objects in the field of view of the cooperative radar system, then these can be identified and simultaneously their position and velocity, and direction of movement, specified with the aid of the procedure described in conjunction with FIG. 4 to FIG. 9.

FIG. 11 to FIG. 20 show once again in detail the method for identification and localization of an object, which was illustrated in conjunction with FIGS. 6 to 10.

FIG. 7 and FIG. 10 show 24 modulated receive signals plotted on top of each other. In each case a different frequency ramp is assigned to the respective receive signals, with which frequency ramp a sensor signal, which has been subsequently modulated by a transponder, has been generated. In FIG. 11 on the other hand the receive signal of just the first ramp is illustrated. The frequency bin 27 has a local peak value with an amplitude of −33.04 dB.

FIG. 12 illustrates the second receive signal, which was generated by the second ramp signal. Here the receive signal has an amplitude of −32.65 dB at the frequency bin 27. The determination of the amplitudes at frequency bin 27 can be repeated in the same way for all 24 ramps. The amplitude is proportional to the signal power. The amplitude values give the quantity in dB (decibels).

FIG. 13 illustrates the 24th receive signal, which was generated by the 24th ramp signal. Here the receive signal has an amplitude of −32.84 dB at frequency bin 27.

If all 24 amplitudes at frequency bin 27 are represented in one graph as a function of the ramp number ZR, then the representation shown in FIG. 14 is produced.

In this regard the first value is the amplitude −33.04 dB of the receive signal of the first ramp, the second value the amplitude −32.65 dB of the receive signal of the second ramp, and the last value the amplitude −32.84 dB of the last ramp. In FIG. 14 a periodic profile of the amplitude values can already be seen, which maps the modulation frequency of the RFID transponder of the detected object.

Since the receive signals follow each other immediately in time, the receive time can also be plotted on the x-axis instead of the number ZR (ramp number) of the receive signal. In this example the receive time per signal is 414 μs.

If a Fourier transform is calculated over the time profile of the amplitude signal, then the amplitude spectrum shown in FIG. 15 is the result. FIG. 15 shows the DC component of the receive signal for a frequency f of 0 Hertz. A strong amplitude is produced for 0 Hz because the receive signal is affected by an offset of around −33.27, which corresponds to an average value of the 24 peak values. In FIG. 15 a smaller subsidiary peak value can already be seen at a modulation frequency f of 600 Hz.

If the amplitude value of the DC component is removed, then the spectrum illustrated in FIG. 16 is produced. Here it can be seen clearly that the biggest frequency component excluding the DC component of the receive signals is situated at around 600 Hz. This value corresponds to the modulation frequency of the RFID transponder of the detected reference object. The curve profile shown in FIG. 16 also becomes visible if the mean value is removed from the receive signal.

The profile of the receive signal with the mean value taken out for the bin 27 is shown in FIG. 17.

FIG. 18 again shows the Fourier transform “in the amplitude direction”. Here the DC component of the signal is 0 because the signal has had the mean value taken out. As a result the biggest frequency component can be defined directly with a search for the peak value. Since the peak value is situated precisely at the modulation frequency of the RFID transponder of the reference object, the target of the frequency bin 27 is identified as the RFID transponder of the reference object.

This procedure has to be repeated for each frequency bin since due to the absence of coherence in the radar system the RFID transponder is situated at an unknown frequency bin. Bin 27 has been chosen here just as an example since it was already known from a previous evaluation that the RFID transponder of the reference object is situated there.

By chance it turns out in the spectrum in FIG. 7 that the frequency bin 49 likewise has the largest frequency component of the amplitude signal at a frequency of approx. 600 Hz. This can be seen in FIG. 19.

To be able to establish unambiguously which frequency bin belongs to the RFID transponder to be identified, the average amplitude of the respective frequency bins can be used. Frequency bin 27 has an average amplitude of −33.27 dB. Since frequency bin 49 is situated in the noise region (see FIG. 7), it only has an average amplitude of −53.83 dB. The possibility that an RFID transponder is involved at bin 49 can therefore be ruled out.

If the Fourier transforms are weighted with the respective average amplitude of the bin then the picture shown in FIG. 20 is produced. In this regard the broken line corresponds to the amplitude profile for bin 49 and the solid line the amplitude profile for bin 27.

Weighting the amplitude profile with the average amplitude of the bin does not necessarily need to be done if all noise bins have previously been excluded from the Fourier transform of the amplitudes (FFT2) by means of a suitable method. This can be accomplished with the aid of a target detection algorithm for example. Following target detection only those frequency bins that have been identified as a target are still investigated for a modulation frequency. However target detection is often more costly in terms of time and computing effort than a weighting with subsequent amplitude comparison.

If the weighted Fourier transforms of the receive signals of all frequency bins are written to the columns of a matrix, then the image shown in FIG. 9 is produced. Here brighter areas are assigned to peak values of the amplitudes.

FIG. 21 shows a flowchart 2100, which illustrates a combined identification and position-determination method according to an exemplary embodiment of the invention.

In step 21.1 a radar signal is initially generated by a radar sensor of a cooperative radar system. In step 21.11 this radar signal is amplitude-modulated by an RFID transponder, which is arranged on an object to be detected and identified. Following amplification of the modulated signal, the modulated signal is sent back to the cooperative radar system. In step 21.111 the modulated signal is captured and mixed by a radar sensor of the cooperative radar system. In the mixing step the modulated signal is mixed with the ramp signal of the radar sensor. In this way a differential signal is generated between the frequency of the modulated signal and the frequency of the receiving radar sensor, which is then also referred to as a beat signal. In step 21.IV the beat signal is sampled. In step 21.V the sampled data, which is assigned to different ramps, is separated from each other. In step 21.VI the first Fourier transform of the sampled signal data is then carried out to generate an amplitude spectrum. Furthermore in step 21.VII the second Fourier transform of the amplitude spectrum is carried out. Then, in step 21.VIII, the frequencies assigned to the individual objects are determined. In this regard, in a quasi-coherent radar sensor detection, the beat frequency of the RFID transponder of the reference object and also the modulation frequency assigned to the RFID transponder are initially determined in the spectrum. Additionally other objects are also identified on the basis of their modulation frequency, and localized on the basis of the beat signal assigned to them.

In step 21.IX, in order to rule out noise effects, the method of amplitude detection illustrated in FIG. 20 is carried out, in which “ghost objects” can be ruled out.

Subsequently further process steps can be taken for determining kinematic variables, such as for example the position, the velocity, or the vectorial velocity of an identified object. In detail this can be done for example by carrying out a determination of the monostatic and bistatic distances of the objects, triangulation, and from this, a position determination for the objects. For the velocity determination, a determination of the Doppler frequencies and velocities of the detected objects can be carried out. Furthermore to determine the vectorial velocity a determination of the direction of movement of the objects can also be carried out.

In conclusion reference is made once more to the fact that the method and devices described above just relate to preferred exemplary embodiments of the invention and that the invention can be varied by a person skilled in the art without departing from the scope of the invention, insofar as it is defined by the claims. For the sake of completeness reference is also made to the fact that the use of the indefinite article “a” does not exclude the eventuality that the relevant features can also be present multiple times. Likewise the term “unit” does not exclude the eventuality that same consists of multiple components, which can also be spatially distributed where appropriate.

1-11. (canceled)

12. A system for identification and localization of an object, the system comprising:
a bistatic frequency modulated continuous wave (FMCW) radar sensor system having at least two FMCW radar sensors, and configured to be operated coherently or quasi-coherently and configured to emit a series of repeating ramp signals;
an active radio frequency identification (RFID) transponder disposed on the object to be identified and localized and set up to generate a modulated bistatic backscatter signal, wherein a ramp signal of the repeating ramp signals sent out by one of said at least two radar sensors at a ramp repetition frequency is modulated with an amplitude modulation signal, a modulation frequency of which is already known and is less than half a ramp repetition frequency; and
an evaluation unit being set up to establish an association between a beat frequency and the modulation frequency of the active RFID transponder, the modulation frequency being an already known modulation frequency, on a basis of the modulated bistatic backscatter signal by means of a first Fourier transform of the modulated bistatic backscatter signal according to the ramp repetition frequency and a second Fourier transform according to an amplitude.

13. The system according to claim 12, wherein said evaluation unit is set up to determine a distance of said active RFID transponder to said bistatic FMCW radar sensor system on a basis of the beat frequency, and to identify the active RFID transponder on a basis of the already known modulation frequency.

14. The system according to claim 12, wherein when said bistatic frequency modulated continuous wave (FMCW) radar sensor system is operating as a quasi-coherent bistatic radar sensor system:
further comprising a reference target with an already known position and a further active RFID transponder with the already known modulation frequency;
wherein said evaluation unit:
is set up to assign a beat frequency to said reference target on a basis of two Fourier transforms and the already known modulation frequency of said reference target; and
further comprising a calibration unit, which is set up to carry out a calibration to determine a corrected beat spectrum on a basis of a bistatic measurement with one of said at least two radar sensors and on a basis of a determined beat frequency of said reference target.

15. The system according to claim 14, wherein said calibration unit is set up to:
determine a frequency of said reference target in an abistatic region on a basis of a determined beat spectrum;
determine a value of a frequency shift of the determined beat spectrum in the bistatic region on a basis of the frequency said reference target in the bistatic region determined by the bistatic measurement and an already known nominal frequency of a bistatic reflection signal of said reference target; and
shift the determined beat spectrum by the value determined of the frequency shift.

16. The system according to claim 12, further comprising a position determination unit, which is set up to:
determine a position of said active RFID transponder on a basis of an assigned said beat frequency;
determine a first transit time of a monostatic reflection signal on a basis of a frequency of the object in a monostatic region of a determined beat spectrum;
determine a second transit time of a bistatic reflection signal on a basis of a frequency of the object in a bistatic region of the determined beat spectrum;
determine distances of said sensors to the object on a basis of the first and second transit times; and
determine a position of the object by triangulation on a basis of the distances determined.

17. The system according to claim 12, further comprising a velocity determination unit, which is set up to:
determine a first Doppler frequency of a monostatic reflection signal of the object in a monostatic region of a beat spectrum;
determine a second Doppler frequency of a bistatic reflection signal of the object in a bistatic region of the beat spectrum;
determine a first velocity component of the object on a basis of the first Doppler frequency;
determine a second velocity component of the object on a basis of the second Doppler frequency and the first velocity component; and
determine a vectorial velocity of the object on a basis of the first velocity component and the second velocity component.

18. The system according to claim 12, wherein said active RFID transponder is one of a plurality of RFID transponders, each of said RFID transponders has a different modulation frequency and each of said RFID transponders is disposed on a different object.

19. The system according to claim 12, wherein said active RFID transponder is one of a plurality of RFID transponders, which are disposed on one and a same said object such that a length and/or a width and/or a height of the object can be estimated with an aid of said RFID transponders.

20. A method for identification and localization of an object, which comprises the steps of:
emitting a series of repeating ramp signals by means of a bistatic frequency modulated continuous wave (FMCW) radar sensor system with at least two FMCW radar sensors, and is configured to operate coherently or quasi-coherently;
generating a modulated bistatic backscatter signal by means of an active radio frequency identification (RFID) transponder, which is disposed on the object to be identified and localized, wherein a ramp signal sent out by one of the at least two radar sensors at a ramp repetition frequency is modulated with an amplitude modulation signal, a modulation frequency of which is already known and is less than half the ramp repetition frequency; and
establishing an association between a beat frequency and the modulation frequency of the active RFID transponder, the modulation frequency is already known, on a basis of the modulated bistatic backscatter signal by means of a first Fourier transform of the modulated backscatter signal according to the ramp repetition frequency and a second Fourier transform according to an amplitude.

21. A non-transitory computer program product with a computer program, which can be loaded directly into a computer unit of a system, with program sections to carry out all steps of the method according to claim 20 when the computer program is executed in the computer unit.

22. A non-transitory computer-readable medium having computer executable instructions which are capable of being executed by a computer unit, to carry out all steps of the method according to claim 20 when the computer executable instructions are executed by the computer unit.
